(19) United States
(12) Patent Application Publication
(10) Pub. No.: US 2019/0292041 A1
(43) Pub. Date: Sep. 26, 2019

(54) IMPROVEMENTS IN OR RELATING TO SADDLES

(71) Applicants: David KEMPSELL, Canterbury Kent (GB); Margaret WHITE, Canterbury Kent (GB)

(72) Inventors: David KEMPSELL, Canterbury Kent (GB); Margaret WHITE, Canterbury Kent (GB)

(21) Appl. No.: 16/345,220

(22) PCT Filed: Oct. 26, 2017
(86) PCT No.: PCT/EP2017/077534

§ 371 Date: Apr. 25, 2019

(30) Foreign Application Priority Data
Oct. 26, 2016 (EP) 1618099.4

(51) Int. Cl. B68C 1/12; B68C 1/08

(52) U.S. Cl. CPC B68C 1/12; B68C 1/08

(57) ABSTRACT

The present invention relates especially to saddles for horses. We describe an insert for a panel (3) of a saddle, the insert comprising: a resilient plate (5) having first and second faces; a foam panel (4) attached to the first face; and a pair of inflatable air bags or bladders (6,7) attached to the second face of the resilient plate. The pair of air bags are arranged in a non-overlapping configuration. Suitably, the resilient plate is formed of a high rigidity polymeric material, such as a polypropylene copolymer. Suitably, the foam is a polyether foam having a density of between 80 and 140 kg/m² and a compressive load deflection of 15-25 kPa. Advantageously, the resilient plate has a stiffness equivalent to the stiffness of a 2 mm thick sheet of a material having a tensile or flexural modulus of elasticity in the range of from 900 MPa to 2000 MPa, preferably in the range of 1000 MPa to 1500 MPa, more preferably in the range of 1000 MPa to 1300 MPa.

The present invention relates to saddles, especially saddles for horses. In particular, it relates to saddles having an excellent fit to the back of a horse.

In our earlier application, EP 0 764 607 A, to which further reference should be made, we describe a method of improving the fit of a saddle by using at least a pair of air-fillable bladders and a foam insert inserted into each panel on respective sides of the underside of the saddle adjacent, in use, to the spine of the horse. The pair of bladders within a panel are overlapped to provide a continuous smooth bearing surface and the air pressure can be adjusted within each bladder so that the saddle's bearing on the horse's back can be adjusted. The foam is positioned between the air bladders and the saddle tree.

This arrangement has been very successful, but does require adjustment of the air pressure within the air bladders. The present invention seeks to provide an alternative saddle construction, but also a construction which is compatible with the methods and apparatus of EP 0 764 607 A.

In its broadest sense, the present invention provides a saddle panel insert or filling for a panel of a saddle, the insert comprising: a resilient plate having first and second faces; a foam panel attached to the first face; and a pair of inflatable air bags or bladders attached to the second face of the resilient plate, wherein the pair of air bags are arranged in a non-overlapping configuration.

Preferably, the resilient plate is formed of a polymeric material, preferably a polymeric material having a high rigidity.

Preferably, the polymeric material is polypropylene.

Alternatively, the polymeric material is a carbon fibre-reinforced polymeric material.

Preferably, the resilient plate has a stiffness substantially equivalent to the stiffness of a 2 mm thick sheet of a material having a tensile modulus of elasticity (as measured according to DIN EN ISO 527 or ASTM D638) or a flexural modulus of elasticity (as measured according to DIN EN ISO 178 or ASTM D790) in the range of from 900 MPa to 2000 MPa, preferably in the range of 1000 MPa to 1500 MPa, more preferably in the range of 1000 MPa to 1300 MPa.

Preferably, the foam is a polyether foam.

Preferably, the foam has a density of between 80 and 140 kg/m², more preferably a density of about 110 kg/m′.

Preferably, the foam has a compressive load deflection of 15-25 kPa, more preferably 18-20 kPa, most preferably about 19 kPa.

Preferably, the foam panel is provided with an overlayer, more preferably an overlayer of a textile, most preferably an overlayer of a polyester fleece textile.

The present invention also provides an insert or filling for a saddle panel, the insert or filling being formed of a polyether foam.

The present invention further provides a panel for a saddle, the panel comprising a panel insert or filling as defined above.

The present invention also provides the use of a polyether foam as an insert or filling for a panel of a saddle.

Preferably, the foam has a density of between 80 and 140 kg/m², more preferably a density of about 110 kg/m′.

Preferably, the foam has a compressive load deflection of 15-25 kPa, more preferably 18-20 kPa, most preferably about 19 kPa.

The above and other aspects of the present invention will now be described in further detail, by way of example only, with reference to the accompanying figures, in which:

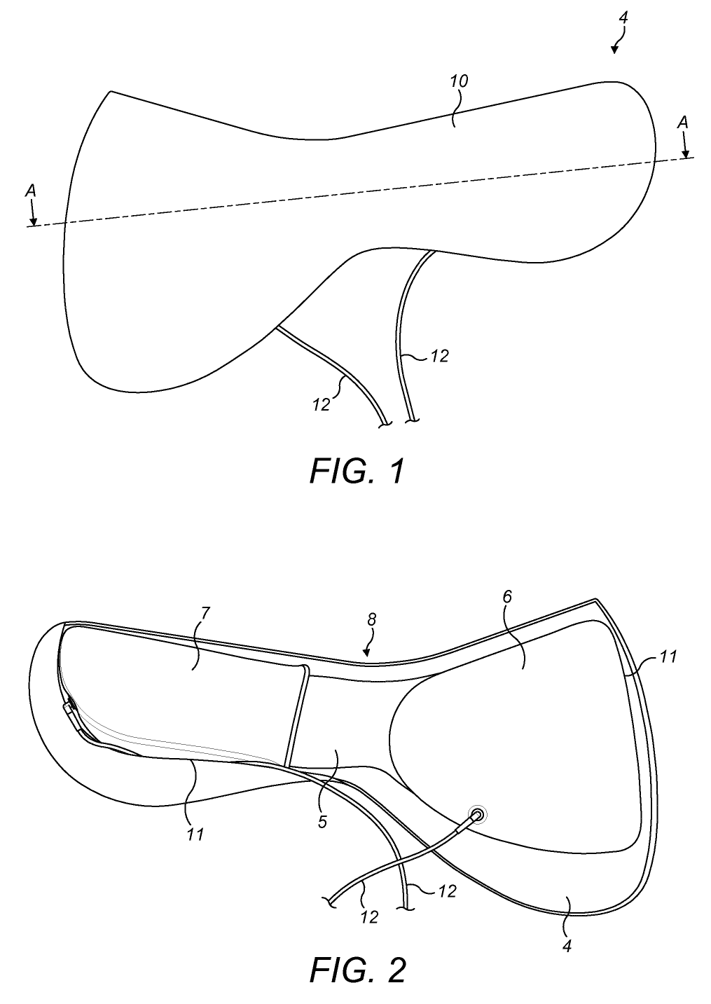

FIG. 1 is an underside view of an embodiment of a saddle panel insert in accordance with the present invention;

FIG. 2 is a top view of the embodiment of FIG. 1;

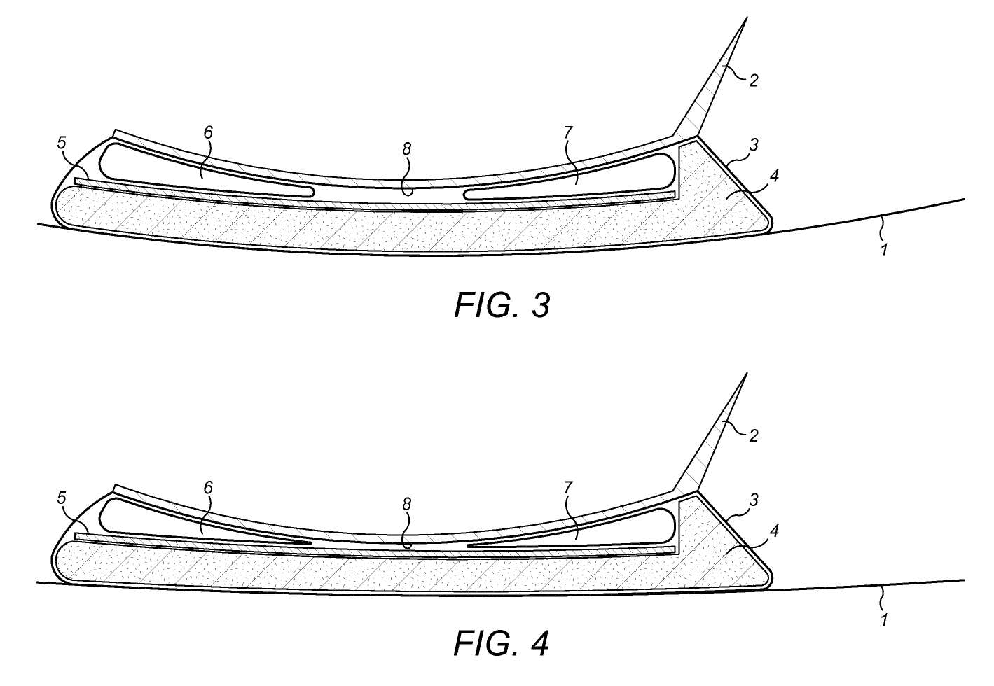

FIG. 3 is a schematic cross-sectional view of the embodiment of FIG. 1 along the orientation of line A-A, shown against a horse's back; and

FIG. 4 is a schematic cross-sectional view of the embodiment of FIG. 1 along the orientation of line A-A, shown against a horse's back having less curvature than that shown in FIG. 3.

Conventionally, panels on the underside of a saddle are filled with wool flock or foam. The aim of the present invention is to provide a panel which can work in the same way as an off-the-shelf wool-flocked or foam-filled panel, but which can also have the option of being adjustable using air as well, as described in our earlier patent application. The air bags or bladders need not be inflated at all but could be used to finesse the fit and balance of the saddle on the horse.

Our earlier invention was designed to fit into the panel of any type of saddle retrospectively, or at the time of manufacture. We wish to achieve the same flexibility of use with the present invention. However, the present invention is particularly well adapted for inclusion in a saddle at the time of manufacture.

With reference to the figures, in one aspect, the present invention relates to a saddle panel insert or a saddle panel into which the insert has been installed. As is conventional, the panel (3) is conveniently formed of leather. The insert as shown in the figures consists of a resilient plate (5) having a foam panel (4) adjacent a first face thereof, the face which is directed, in use, to the back (1) of the horse; and front (6) and back (7) air bags or bladders adjacent the second face, the face which, in use, is directed towards the saddle tree (2) of the saddle. The terms front and back refer to the front or head end of the saddle and the rear end of the saddle respectively.

As shown most clearly in FIGS. 3 and 4, front and back air bags (6,7) are spaced such that there is no overlap between the bags as is the case with our earlier invention and there is a space or gap between the two bags. Furthermore, the air bags are designed and sized such that they fit the shape of the underside of the tree and the top of the panel profile without extending or expanding beyond. This is in contradistinction to the function of the air bags in our earlier invention which are intended to extend to fill and fit the shape of the leather panel.

The resilient plate (5) formed of a resilient material which has a high degree of rigidity, without being completely unyielding under pressure. Suitable materials will be discussed below. The rigidity of the resilient plate overcomes the possibility that the air bag, when inflated, develops a rounder profile than is required, which might cause a pressure point rather than provide the desired effect of lifting the corresponding area of the saddle above the particular air bag.

Accordingly, this embodiment works in a completely different way to the apparatus described in our earlier application. The air bags are relatively smaller and do not overlap in the middle of the panel. They do roll over in the corners of the panel so the corner is filled and the panel produces lift. The bags are contained under the tree, whereas those of our earlier product act more like small pneumatic jacks under the tree of the saddle, acting on the resilient layer under them and the solid panel top and tree above.

Front and back air bags (6,7) are preferably secured to the resilient plate (5). The air bags (6,7) may be adhered to the place (5) using a suitable adhesive or a double-sided adhesive tape. In preferred embodiments, the bags (6,7) are held in place by a pocket formed by adhering or stitching a fabric (11) to the resilient plate. Cordura has been determined to have excellent properties to achieve this desired result.

The air bags (6,7) are provided with tubes (12) for inflation. It will be appreciated that the tubes are provided with appropriate valves to allow admission of air but prevent loss of air in use and that ends to the tubes will be positioned in the saddle at a convenient point to allow inflation. Our earlier application describes these features in more detail and so they will not be described here.

The resilient plate (5) should be sufficiently resilient or stiff to resist flexing under the pressure exerted by the air bags (6,7), especially under the additional pressures produced in use through compression by the rider's body and movement of the rider's body. Polystone P Copolymer (a registered trade mark of Rochling Engineering Plastics) at 2 mm thickness has been found to be particularly suitable for our purposes. Polystone P Copolymer is a block copolymer having a tensile modulus of elasticity of 1100 MPa elasticity (as measured according to DIN EN ISO 527 or ASTM D638). Materials other than polypropylene are equally suitable for use in the present invention, for example carbon fibre composites. Accordingly, we have determined that materials forming the resilient plate preferably have a similar stiffness to a 2 mm thick sheet of a material having a tensile modulus of elasticity (as measured according to DIN EN ISO 527 or ASTM D638) or a flexural modulus of elasticity (as measured according to DIN EN ISO 178 or ASTM D790) in the range of from 900 MPa to 2000 MPa, more preferably in the range of 1000 MPa to 1500 MPa.

Carbon fibre-reinforced polymeric materials also provide excellent results, and the laying up of the layers of the fibres allows greater control of the stiffness of the material in specific areas and directions, to give even better pressure distribution throughout the panel.

The resilient plate (5) is adhered to the upper surface of the foam by means of an adhesive, conveniently a contact adhesive, suitably applied as a spray or brushed on.

The foam used in saddle panels contributes to the overall ride quality of the saddle, for both horse and rider. Conventionally, the foam for a panel insert has been formed by moulding a foam precursor to the shape of the panel. However, foam moulding does not always give a consistent and uniform foam density, for a range of reasons. Preparing foam precursors in small batches rarely gives a consistent mixture, due to small variations in the amounts of components used and the consistency of mixing. Environmental aspects such as a consistent and uniform temperature throughout the mould, and ambient temperature and humidity, all have an impact on the final foam.

Accordingly, we have determined that the foam for the inventive panel inserts is most suitably formed from large blocks of foam, which are manufactured in large batches under consistent factory conditions. The blocks of foam are then cut into sheets and carved to the desired shape. The carving can be by hand, but we have found that carving the foam panel inserts (4) on a CNC (computer numerical control) router provides excellent results. The foam inserts can be produced consistently and the design of the insert can be changed easily and quickly to suit different sizes and shapes of panel.

We have determined that polyether foams perform excellently for our purposes. They are soft foams but have good resilience. In particular, we have found that polyether foams having a density of between 80 and 140 kg/m′ have good properties, especially those having a density of about 110 kg/m′. More particularly, we have found that a polyether foam obtainable from Fritz Nauer AG under product code SRT 110190 is especially suitable. SRT 110190 has a density of 110 kg/m² and a compressive load deflection of 19 kPa.

Optionally, the foam panel (4) is provided with a polyester fleece textile or other lining (10) on the side of the insert facing the horse's back (FIG. 1) to add resilience and strength to the foam and aid insertion of the foam panel into the leather panel casing (3) of the saddle without causing damage due to tearing or catching. The lining (10) also enhances the look and feel of the loaded leather panel (3).

The operation of the panel in use is most clearly shown by comparing FIGS. 3 and 4. With the air bags (6,7) inflated, the resilient panel (5) will float below the air bags and the middle of the resilient panel (5) will either touch or float clear of the top of the panel (3), depending upon the shape of the horse's back and how the horse lifts its back whilst being ridden, giving a different profile from when standing. The contact throughout the length of the panel (3) is not dependent upon the amount of air in the air bags, but the resilient plate which is bowed towards the horse at all time due to it being already bent and twisted around the base of the saddle tree.

Furthermore, we have found that the properties of the foam render it suitable for use in panels without the need for air bags. Accordingly, in a further aspect, the present invention provides a saddle panel having a conventional outer skin with a polyether foam liner having a density of between 80 and 140 kg/m′, preferably about 110 kg/m′.

In that context, the panel can be modified to include either the air bags and resilient plate as we have described above or to include a pair of overlapping air bags or bladders as described in our earlier patent application. This forms a yet further aspect of the present invention.

In preferred embodiments in which the panel includes both foam and air bags, the foam represents over 50% of the volume of the panel when the air bags are inflated, preferably around 70-80%.

1. A saddle panel insert for a panel of a saddle, the insert comprising: a resilient plate having first and second faces; a foam panel attached to the first face; and a pair of inflatable air bags or bladders attached to the second face of the resilient plate, wherein the pair of air bags are arranged in a non-overlapping or spaced configuration providing a space therebetween.

2. The insert as claimed in claim 1, wherein the resilient plate is formed of a high rigidity polymeric material.

3. The insert as claimed in claim 2, wherein the polymeric material is polypropylene.

4. The insert as claimed in claim 2, wherein the polymeric material is a carbon fibre-reinforced polymeric material.

5. The insert as claimed in claim 1, wherein the foam is a polyether foam.

6. The insert as claimed in claim 1, wherein the foam has a compressive load deflection of 15-25 kPa.

7. The insert as claimed in claim 1, wherein the foam panel is provided with an overlayer.

8. An insert or filling for a saddle panel, the insert or filling being formed of a polyether foam.

9. The insert as claimed in claim 8, wherein the polyether foam has a density of between 80 and 140 kg/m².

10. The insert as claimed in claim 8, wherein the foam has a compressive load deflection of 15-25 kPa.

11. The insert as claimed in claim 1, wherein the resilient plate has a stiffness equivalent to the stiffness of a 2 mm thick sheet of a material having a tensile modulus of elasticity (as measured according to DIN EN ISO 527 or ASTM D638) or a flexural modulus of elasticity (as measured according to DIN EN ISO 178 or ASTM D790) in the range of from 900 MPa to 2000 MPa.

12. A panel for a saddle, the panel comprising the saddle panel insert for a panel of a saddle as claimed in claim 1.

13. A method of using a polyether foam as an insert or filling for a panel of a saddle, the method comprising inserting or filling a panel of a saddle with a polyether foam.

14. (canceled)

15. (canceled)

16. The insert as claimed in claim 5, wherein the foam is a polyether foam, having a density of between 80 and 140 kg/m².

17. The insert as claimed in claim 5, wherein the foam is a polyether foam, having a density of about 110 kg/m².

18. The insert as claimed in claim 6, wherein the foam has a compressive load deflection of 15-25 kPa.

19. The insert as claimed in claim 6, wherein the foam has a compressive load deflection of 19 kPa.

20. The insert as claimed in claim 9, wherein the polyether foam has a density of about 110 kg/m².

21. The insert as claimed in claim 10, wherein the foam has a compressive load deflection of 18-20 kPa.

22. The insert as claimed in claim 11, wherein the resilient plate has a stiffness equivalent to the stiffness of a 2 mm thick sheet of a material having a tensile modulus of elasticity (as measured according to DIN EN ISO 527 or ASTM D638) or a flexural modulus of elasticity (as measured according to DIN EN ISO 178 or ASTM D790) in the range of from 1000 MPa to 1500 MPa.
